(19) United States
(12) Patent Application Publication
(10) Pub. No.: US 2026/0064988 A1
(43) Pub. Date: Mar. 5, 2026

(54) VIDEO SCRIPT GENERATION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Feng NIE, Beijing (CN); Baoxuan LIU, Beijing (CN); Guannan LV, Beijing (CN); Dongliang HE, Beijing (CN); Mingke SONG, Beijing (CN); Shuhan XU, Beijing (CN); Zhichao ZHOU, Beijing (CN); Haiyu ZHAO, Beijing (CN)

(21) Appl. No.: 19/316,929

(22) Filed: Sep. 2, 2025

(30) Foreign Application Priority Data
Sep. 3, 2024 (CN) 202411230693.3

(51) Int. Cl. G06F 40/40; G06V 20/40; G11B 27/031

(52) U.S. Cl. CPC G06F 40/40; G06V 20/46; G06V 20/49; G11B 27/031

(57) ABSTRACT

Embodiments of the present disclosure provide a video script generation method and apparatus, an electronic device, and a storage medium. User input data is acquired and the user input data includes a video requirement parameter, and the video requirement parameter at least represents a video content feature of a video to be generated. A pre-trained large language model processes the user input data to generate first script data, and the first script data includes at least two scene description texts for the video to be generated, and the scene description texts are used to describe image content under a video storyboard in a target video.

### CROSS-REFERENCE TO RELATED APPLICATION(S)

This application claims priority to Chinese Application No. 202411230693.3 filed in Sep. 3, 2024, the disclosure of which is incorporated herein by reference in its entity.

### FIELD

Embodiments of the present disclosure relate to the field of video processing technology, and in particular, to a video script generation method and apparatus, an electronic device, and a storage medium.

### BACKGROUND

Currently, an increasing number of users begin to utilize some video production applications (APPs) for video creation. Before creating a video, the user needs to shoot a raw video, and then the user edits the raw video through the video production application, thereby completing video creation. When shooting the raw video, the user needs to complete a series of shooting according to video storyboards.

### SUMMARY

Embodiments of the present disclosure provide a video script generation method and apparatus, an electronic device, and a storage medium, to solve the problems of high costs and low quality of video work shooting.

In a first aspect, an embodiment of the present disclosure provides a video script generation method, including:
acquiring user input data, wherein the user input data includes a video requirement parameter, and the video requirement parameter at least represents a video content feature of a video to be generated; and processing the user input data through a pre-trained large language model to generate first script data, wherein the first script data includes at least two scene description texts for the video to be generated, and the scene description texts are used to describe image content under a video storyboard in a target video.

In a second aspect, an embodiment of the present disclosure provides a video script generation apparatus, including:
an acquisition unit, configured to acquire user input data, wherein the user input data includes a video requirement parameter, and the video requirement parameter at least represents a video content feature of a video to be generated; and a processing unit, configured to process the user input data through a pre-trained large language model to generate first script data, wherein the first script data includes at least two scene description texts for the video to be generated, and the scene description texts are used to describe an image content under a video storyboard in a target video.

In a third aspect, an embodiment of the present disclosure provides an electronic device, including: a processor and a storage apparatus;
the storage apparatus stores computer-executable instructions; and
the processor, when executes the computer-executable instructions stored in the storage apparatus, causes the at least one processor to perform the video script generation method according to the first aspect and various possible designs in the first aspect described above.

In a fourth aspect, an embodiment of the present disclosure provides a computer-readable storage medium, and the computer-readable storage medium stores computer-executable instructions therein. A processor, when executes the computer-executable instructions, implements the video script generation method according to the first aspect and various possible designs in the first aspect described above.

In a fifth aspect, an embodiment of the present disclosure provides a computer program product, and the computer program product includes a computer program. The computer program, when executed by a processor, implements the video script generation method according to the first aspect and various possible designs in the first aspect described above.

### BRIEF DESCRIPTION OF THE DRAWINGS

In order to describe the technical solutions in embodiments of the present disclosure or the prior art more clearly, the accompanying drawings required for describing the embodiments or the prior art will be briefly introduced below. Apparently, the accompanying drawings described below are some embodiments of the present disclosure, and those of ordinary skill in the art can also derive other accompanying drawings from these accompanying drawings without creative efforts.

FIG. 1 is a diagram of an application scenario of a video script generation method according to an embodiment of the present disclosure;

FIG. 2 is a first schematic flowchart of a video script generation method according to an embodiment of the present disclosure;

FIG. 3 is a schematic diagram of a process of generating the first script data according to an embodiment of the present disclosure;

FIG. 4 is a second schematic flowchart of a video script generation method according to an embodiment of the present disclosure;

FIG. 5 is a flowchart of a specific implementation for step S202 in the embodiment shown in FIG. 4;

FIG. 6 is a schematic diagram of a process of generating the second script data according to an embodiment of the present disclosure;

FIG. 7 is a flowchart of a specific implementation for step S2021 in the embodiment shown in FIG. 5;

FIG. 8 is a schematic diagram of a process of generating an initial scene description text corresponding to a material video using a multimodal processing model according to an embodiment of the present disclosure;

FIG. 9 is a schematic diagram of a process of generating the first script data of a video to be generated according to an embodiment of the present disclosure;

FIG. 10 is a structural block diagram of a video script generation apparatus according to an embodiment of the present disclosure;

FIG. 11 is a schematic structural diagram of an electronic device according to an embodiment of the present disclosure; and

FIG. 12 is a schematic diagram of a hardware structure of an electronic device according to an embodiment of the present disclosure.

### DETAILED DESCRIPTION OF EMBODIMENTS

In order to have a clearer understanding of the objectives, technical solutions, and advantages of embodiments of the present disclosure, the technical solutions in the embodiments of the present disclosure are clearly and completely described in conjunction with the accompanying drawings in the embodiments of the present disclosure, and it is apparent that the described embodiments are only a part rather all of embodiments of the present disclosure. Based on the embodiments of the present disclosure, all other embodiments obtained by those of ordinary skill in the art without contributing creative work shall fall within the scope of protection of the present disclosure.

It should be noted that user information (including but not limited to user device information, user personal information, etc.) and data (including but not limited to data for analysis, stored data, displayed data, etc.) involved in the present disclosure are all information and data authorized by a user or sufficiently authorized by each side, and related data collection, use, and processing need to comply with relevant laws, regulations, and standards of related countries and regions. A corresponding operation entrance is provided for the user to select for authorization or refusal.

Application scenarios for the embodiments of the present disclosure are described below:

A video script generation method provided in an embodiment of the present disclosure may be applied to an application (APP) with a video production function, such as a camera application, a video editing application, and a short video application, etc., and more specifically, may be applied to an application scenario where a raw video is shot according to a generated video script. An executing entity of this embodiment may be a terminal device running the above-mentioned application with the video production function, or may also be a server deploying a server side corresponding to the above-mentioned application, or other electronic devices with similar functions.

In some embodiments, the terminal device or the server may implement the video script generation method provided in this embodiment of this application by running various computer-executable instructions or computer programs. For example, the computer-executable instructions may be program-level commands, machine instructions, or software instructions. The computer program may be a native program or a software module in an operating system, which may be a local application, i.e., a program that needs to be installed in the operating system to run, or may be a mini-program embedded in any APP, i.e., a program running based on a browser environment. In summary, the above-mentioned computer-executable instructions may be instructions in any form, and the above-mentioned computer programs may be applications, modules, or plugins in any form, with specific implementation forms configurable as needed. Further, in some embodiments, the server may be an independent physical server, may also be a server cluster or a distributed system composed of a plurality of physical servers, or may also be a cloud server providing basic cloud computing services such as a cloud service, cloud storage, cloud communication, a cloud database, cloud computing, a cloud function, a network service, a middleware service, a domain name service, a security service, a content delivery network (CDN), as well as big data and artificial intelligence platforms, wherein the cloud service may be an interactive processing service invoked by the terminal device.

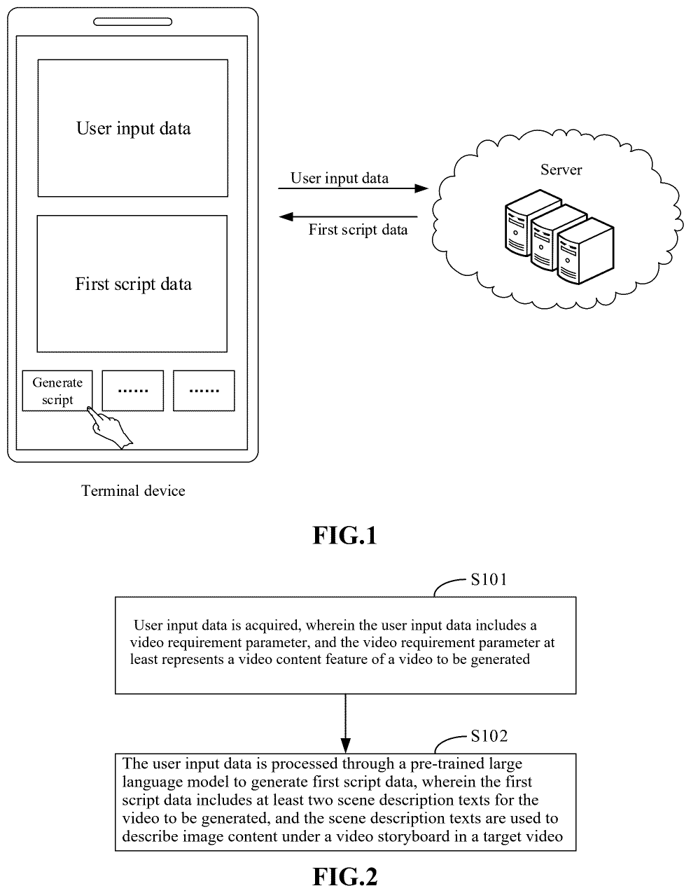

FIG. 1 is a diagram of an application scenario of a video script generation method according to an embodiment of the present disclosure. Referring to FIG. 1, taking a case that a server is an executing entity as an example, an application with a video production function (hereinafter referred to as the application) runs within a terminal device. After loading user input data through the application, by triggering a corresponding functional component, such as a “Generate script” component shown in the figure, the terminal device sends the user input data to the server side for processing. The server, using the method provided in this embodiment, invokes a pre-trained large language model to process the user input data to generate corresponding first script data and then sends the first script data back to the terminal device for display on the terminal device side, thereby allowing the user to determine video storyboards according to the first script data, and then completing shooting of a raw video. Certainly, it should be understood that in another possible implementation, the executing entity of the method provided in this embodiment may also be the terminal device itself, that is, the above-mentioned processing process is completely performed by the terminal device. Models and algorithms used in the execution process may all be locally deployed on the terminal device, or partially locally deployed on the terminal device and partially deployed on an external device and invoked by the terminal device. A specific implementation process is similar and will not be repeated herein.

In the prior art, the above-mentioned solution of determining the video storyboards is typically implemented based on manual design. That is, the user needs to design a video storyboard content of a video to be shot by himself according to his own historical shooting experience, thereby completing the shooting of the raw video. Specifically, for example, the user needs to shoot a video introducing a power adapter with a fast charging function, the user needs to design video storyboard content of a video to be shot by himself according to his own historical shooting experience. For example, the user designs a shot of using the power adapter to quickly charge a phone to a full capacity state, “quickly charging to a full capacity state” is a video storyboard of a close-up shot. The user then completes the shooting of the video “introducing a power adapter with a fast charging function” according to the video storyboard of the close-up shot. However, designing the video storyboard content of the video to be shot by himself according to his own historical shooting experience shows high user subjectivity, leading to the problems of high costs and low quality in video work shooting.

A video script generation method is provided in this embodiment of the present disclosure to solve the above-mentioned problems.

Referring to FIG. 2, FIG. 2 is a first schematic flowchart of a video script generation method according to an embodiment of the present disclosure. The method in this embodiment may be applied to a server, a terminal device, or another electronic device. The video script generation method includes:

Step S101: User input data is acquired, wherein the user input data includes a video requirement parameter, and the video requirement parameter at least represents a video content feature of a video to be generated.

Step S102: The user input data is processed through a pre-trained large language model to generate first script data, wherein the first script data includes at least two scene description texts for the video to be generated, and the scene description texts are used to describe image content under a video storyboard in a target video.

Referring to the schematic diagram of the application scenario in FIG. 1, in this embodiment, the server is used as the executing entity to introduce the provided video script generation method. Exemplarily, a server side corresponding to an application with a video production function is deployed within the server, and the terminal device runs a client of the application. The server and the terminal device are based on communication between the server side and the client, thereby obtaining the user input data sent by the terminal device. The user input data corresponds to the video requirement parameter of the video to be shot by the user. The video requirement parameter at least represents the video content feature of the video to be generated. Specifically, for example, the user needs to shoot a video introducing a power adapter with a fast charging function. Exemplarily, the user input data is “Generate a video script of introducing a power adapter with a fast charging function”, the video requirement parameter is “a power adapter with a fast charging function”, and the video content features are “fast charging” and “a power adapter”. Further, after receiving the user input data, the server processes the user input data by invoking the pre-trained large language model, thereby generating the first script data, wherein the first script data includes the at least two scene description texts for the video to be generated, and the scene description texts are used to describe the image content under the video storyboard in a target video. Specifically, for example, the pre-trained large language model generates the two scene description texts for the video to be generated according to the user input data “Generate a video script of introducing a power adapter with a fast charging function”, the first scene description text is “A man wakes up in the morning and finds that his phone battery is running low, and he needs to leave for the airport in 20 minutes to catch a flight”, and the second scene description text is “The man uses a power adapter with a fast charging function to charge the phone. From the time he starts charging the phone until it is fully charged, the man finishes eating a sandwich, and exactly 10 minutes have passed”. Then, the server sends the first script data generated by the pre-trained large language model back to the terminal device for display on one side of the terminal device, thereby allowing the user to determine the video storyboard according to the first script data, and then completing shooting of a raw video.

In a possible implementation, the user input data further includes a video copy. Correspondingly, the first script data includes at least two copy clauses constituting the video copy, the copy clauses correspond one-to-one with the scene description texts, and the scene description texts are generated based on corresponding copy clauses.

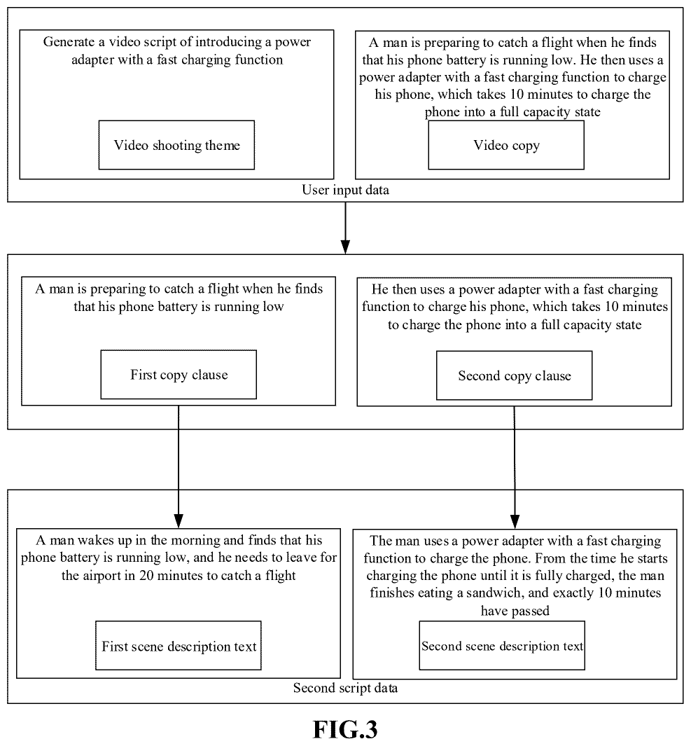

FIG. 3 is a schematic diagram of a process of generating the first script data according to an embodiment of the present disclosure. As shown in FIG. 3, “Generate a video script of introducing a power adapter with a fast charging function” is used as a video shooting theme corresponding to user input data, and a video copy in the user input data is “A man is preparing to catch a flight when he finds that his phone battery is running low. He then uses a power adapter with a fast charging function to charge his phone, which takes 10 minutes to charge the phone into a full capacity state”. Then, a pre-trained large language model splits, according to the video shooting theme and the video copy, the video copy into at least two copy clauses. For example, the two copy clauses are split, the first copy clause is “A man is preparing to catch a flight when he finds that his phone battery is running low”, and the second copy clause is “He then uses a power adapter with a fast charging function to charge his phone, which takes 10 minutes to charge the phone into a full capacity state”. Then, the pre-trained large language model generates two scene description texts for a video to be generated based on the video shooting theme and the two copy clauses, that is, the first script data is generated. The copy clauses correspond one-to-one with the scene description texts. The first scene description text is “A man finds that his phone battery is almost running out after waking up in the morning, and he needs to leave for the airport to catch a flight in 20 minutes”, and the first scene description text is generated based on the first copy clause. The second scene description text is “The man uses a power adapter with a fast charging function to charge the phone. From the time he starts charging the phone until it is fully charged, the man finishes eating a sandwich, and exactly 10 minutes have passed”, and the second scene description text is generated based on the second copy clause.

Further, after step S102, the method may further include:

Step S103: A shooting guidance video of the video to be generated is generated according to the first script data, wherein the shooting guidance video includes at least two shooting guidance video frames corresponding one-to-one with the scene description texts for the video to be generated.

Optionally, a corresponding scene description text and/or a copy clause are displayed within each shooting guidance video frame. The scene description text and/or the copy clause correspondingly displayed within each shooting guidance video frame are used to prompt the user of main content to be correspondingly shot by the shooting guidance video frame.

Exemplarily, after the pre-trained large language model generates the first script data, the server further invokes the pre-trained large language model to generate the shooting guidance video of the video to be generated according to the first script data, thereby facilitating the user to visually shoot the raw video according to the shooting guidance video, wherein the shooting guidance video includes the at least two shooting guidance video frames, and the shooting guidance video frames corresponds one-to-one with the scene description texts for the video to be generated. Specifically, for example, the first scene description text is “A man finds his phone battery is running low after waking up in the morning, and he needs to leave for the airport to catch a flight in 20 minutes”, a scene displayed by a first shooting guidance video frame generated by the pre-trained large language model includes “A man is stretching lazily in bed, while the indoor smart speaker voice-announces the man's schedule and daily reminders: ‘Good morning, sir. The current time is 7:00 a.m. You need to leave for the airport in 20 minutes. Meanwhile, your phone battery is running low and needs to be charged as soon as possible to avoid delaying your trip’, and the brightness of the bedroom gradually increases from dark to light”. Further, optionally, the scene displayed by the first shooting guidance video frame further includes the first scene description text. Exemplarily, the first scene description text may be located in a lower area of the scene displayed by the first shooting guidance video frame, thereby facilitating the user to rapidly determine, according to the scene description text (and/or the copy clause), the main content correspondingly shot by the shooting guidance video frame.

In this embodiment, the user input data is acquired and the user input data includes the video requirement parameter, and the video requirement parameter at least represents the video content feature of the video to be generated; and the pre-trained large language model processes the user input data to generate the first script data, the first script data includes the at least two scene description texts for the video to be generated, and the scene description texts are used to describe the image content under the video storyboard in a target video. Since the pre-trained large language model is trained based on a large number of video script data from a large number of users, on the basis of acquiring the user input data, the pre-trained large language model processes the video content features of the video to be generated corresponding to the user input data, and accordingly the first script data that guides the user to shoot the raw video can be generated. The first script data includes the at least two scene description texts for the video to be generated (the raw video), and the scene description texts correspond to the image content under the video storyboard in the target video, thereby allowing the user to complete shooting of the raw video according to the scene description texts, and solving the problems of high costs and low quality of video work shooting caused by the user designing the video storyboard content of the video to be shot by himself according to his own historical shooting experience.

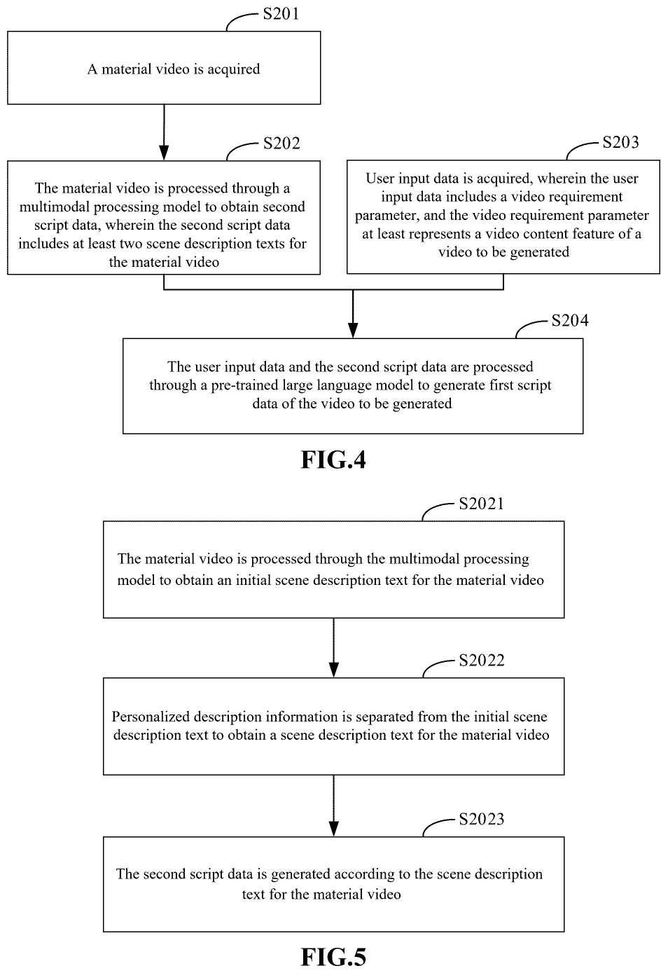

Referring to FIG. 4, FIG. 4 is a second schematic flowchart of a video script generation method according to an embodiment of the present disclosure. Based on the embodiment shown in FIG. 2, this embodiment further refines step S102. The video script generation method includes:

Step S201: A material video is acquired.

Step S202: The material video is processed through a multimodal processing model to obtain second script data, wherein the second script data includes at least two scene description texts for the material video.

Exemplarily, the multimodal processing model is a machine learning model capable of processing and fusing different types of data sources (e.g., a text, an image, audio, and a video). After the server receiving the material video, it processes the material video by invoking the multimodal processing model. Specifically, the multimodal processing model processes and analyzes a text, an image, and audio in the material video to generate the scene description texts for the material video, i.e., obtaining the second script data, wherein the second script data includes the at least two scene description texts for describing the material video.

In a possible implementation, FIG. 5 is a flowchart of a specific implementation for step S202 in the embodiment shown in FIG. 4. As shown in FIG. 5, the specific implementation for step S202 includes:

Step S2021: The material video is processed through the multimodal processing model to obtain an initial scene description text for the material video.

Step S2022: Personalized description information is separated from the initial scene description text to obtain a scene description text for the material video.

Step S2023: The second script data is generated according to the scene description text for the material video.

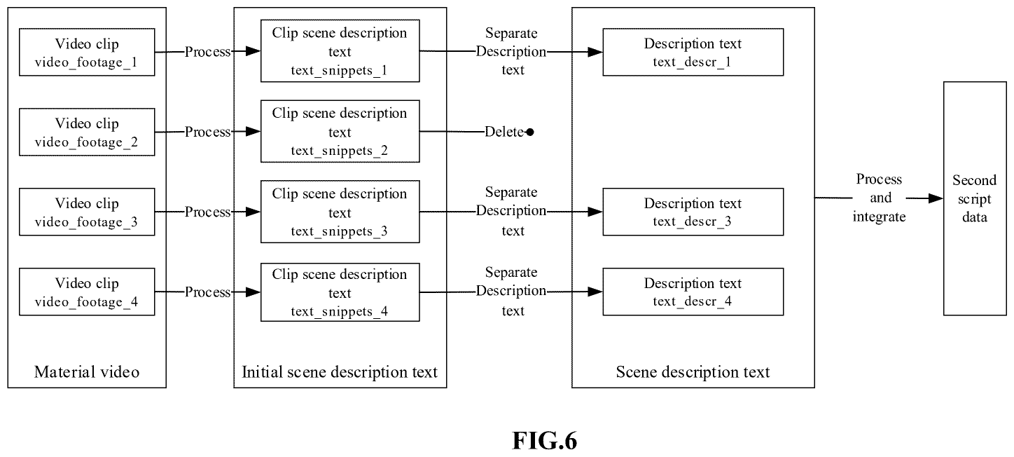

Exemplarily, FIG. 6 is a schematic diagram of a process of generating the second script data according to an embodiment of the present disclosure. As shown in FIG. 6, for a 2-minute material video including 4 video clips, the multimodal processing model processes the material video to obtain an initial scene description text for the material video. The initial scene description text includes clip scene description texts equal in number to the video clips, meaning that the 4 video clips are processed to obtain the initial scene description text. The initial scene description text includes 4 clip scene description texts, and the 4 clip scene description texts correspond one-to-one with the 4 video clips. That is, the video clip video_footage_1 corresponds to the clip scene description text text_snippets_1, the video clip video_footage_2 corresponds to the clip scene description text text_snippets_2, the video clip video_footage_3 corresponds to the clip scene description text text_snippets_3, and the video clip video_footage_4 corresponds to the clip scene description text text_snippets_4. Further, if a core theme of the material video is a video introducing a power adapter with a fast charging function, the power adapter and an electronic device related to the power adapter are core shooting objects in the material video. Then, if the clip scene description text includes description texts about the power adapter and the related electronic device, the description texts are separated out. If the clip scene description text does not include the description texts about the power adapter and the related electronic device, the clip scene description text is deleted, thereby achieving the separation of the personalized description information from the initial scene description text. All the separated description texts are the scene description texts for the material video, and then are aggregated and processed to obtain the second script data. Exemplarily, the clip scene description texts text_snippets_1, text_snippets_3, and text_snippets_4 all include the description texts (the personalized description information) about the power adapter and the related electronic device, accordingly, the above-mentioned at least three description texts are separated out. The clip scene description text text_snippets_2 does include the description text about the power adapter and the related electronic device, and accordingly the clip scene description text text_snippets_2 is deleted. All the above-mentioned separated description texts are scene description texts for the material video, and the scene description texts include the description texts text_descr_1, text_descr_3, and text_descr_4. Then, the scene description texts for the material video are processed and integrated to generate the second script data.

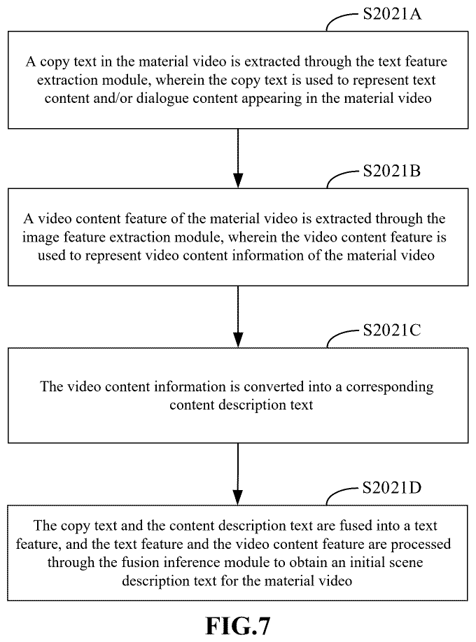

Further, exemplarily, the multimodal processing model includes an image feature extraction module, a text feature extraction module, and a fusion inference module. FIG. 7 is a flowchart of a specific implementation for step S2021 in the embodiment shown in FIG. 5. As shown in FIG. 7, the specific implementation for step S2021 includes:

Step S2021A: A copy text in the material video is extracted through the text feature extraction module, wherein the copy text is used to represent text content and/or dialogue content appearing in the material video.

Step S2021B: A video content feature of the material video is extracted through the image feature extraction module, wherein the video content feature is used to represent video content information of the material video.

Step S2021C: The video content information is converted into a corresponding content description text.

Step S2021D: The copy text and the content description text are fused into a text feature, and process the text feature and the video content feature through the fusion inference module to obtain an initial scene description text for the material video.

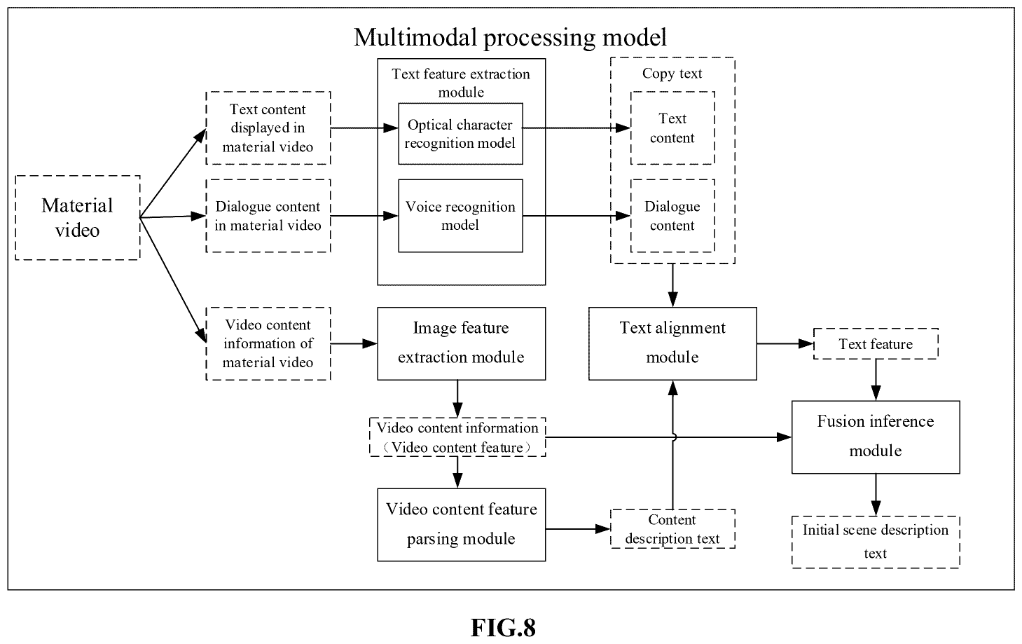

Exemplarily, FIG. 8 is a schematic diagram of a process of generating an initial scene description text corresponding to a material video using a multimodal processing model according to an embodiment of the present disclosure. The following is an introduction of the above-mentioned process of generating the initial scene description text in conjunction with FIG. 8. As shown in FIG. 8, text content and/or dialogue content appearing in the material video can be obtained through extraction using the text feature extraction module, that is, a copy text in the material video is obtained. Specifically, for example, the text feature extraction module includes a voice recognition model and/or an optical character recognition model, if a scene within the material video displays a text subtitle, namely displaying text content, the optical character recognition model may extract the text content, thereby obtaining the copy text in the material video. Further, if the displayed text content in the material video has different colors based on different character roles, for example, the text content corresponding to a character role person_1 is displayed in red, the text content corresponding to a character role person_2 is displayed in blue, the text content corresponding to a narration is displayed in black, the optical character recognition model extracts the text content and classifies the text content according to the colors corresponding to the text content, thereby obtaining the copy text in the material video classified based on different character roles. Further, the voice recognition model may also extract the dialogue content within the material video, thereby obtaining the copy text in the material video. The voice recognition model may extract the dialogue content within the material video without distinguishing sound feature information (e.g., timbre, pitch, and volume) of the dialogue content, thereby obtaining the copy text without classification features from the material video. Alternatively, the voice recognition model may extract the dialogue content through classification according to the sound feature information, thereby obtaining the copy text with classification features based on the sound feature information. It should be understood that for video features of the material video, the text feature extraction module may extract the copy text based on the voice recognition model and/or the optical character recognition model. For example, if the material video is silent with subtitles, the optical character recognition model extracts the copy text. If the material video has sound without subtitles, the voice recognition model extracts the copy text. If the material video has sound and subtitles, any model may be applied to extract the copy text, or both the voice recognition model and the optical character recognition model may be applied to extract the copy text. When the two models are simultaneously applied to extract the copy text, the copy text extraction and/or classification accuracy can be further enhanced, providing accurate intermediate process data (the copy text) for subsequent generation of the initial scene description text and the second script data. Optionally, the above-mentioned copy text may have timestamps.

Further, as shown in FIG. 8, the video content information of the material video can be obtained by extracting the material video through the image feature extraction module, that is, a video content feature of the material video is obtained. Specifically, for example, the image feature extraction module extracts changes in the video content of the material video. For example, the material video presents a process of an electronic device charging from a low battery level to a full charge state, the image feature extraction module generates the corresponding video content information (the video content feature) based on the battery level change process of the electronic device shown in the material video. The video content information describes battery level change processes of the electronic device at different moments. Further, the multimodal processing model further includes a video content feature parsing module. The video content feature parsing module converts the video content information (the video content feature) to output the corresponding content description text. That is, the video content feature (a change feature) of the material video is described in the form of a text. For example, the video content information describes the battery level change processes of the electronic device at different moments. The video content feature parsing module converts the video content information, the output content description text is “At time_1, the battery level of the electronic device is 15%, and the electronic device is connected to a power adapter to begin charging. At time 2, the electronic device is charged to 80%. At time_3, the electronic device is fully charged to 100%”.

Further, as shown in FIG. 8, the multimodal processing model further includes a text alignment module. The text alignment module performs text alignment on the copy text and the content description text according to the timestamps, and then fuses the copy text and the content description text into a text feature. Specifically, for example, at the timestamp time_1, the copy text is “This man takes out a power adapter with a fast charging function to charge his electronic device. Can this electronic device be fully charged within 10 minutes?”. Correspondingly, the content description text is “At time_1, the battery level of the electronic device is 15%, and the electronic device is connected to the power adapter to begin charging”. The text alignment module then aligns and fuses the copy text and the content description text according to the same timestamp to generate a corresponding text feature. Further, the text feature and the video content feature are processed based on the fusion inference module, that is, the fused text feature and the corresponding video content feature are subjected to alignment fusion and logical inference to obtain an initial scene description text for describing the material video. Specifically, for example, at the timestamp time_1, the video content feature is “Use the power adapter to charge the electronic device with a low battery level”, and the fused text feature is: “At time_1, the battery level of the electronic device is 15%, and a man takes out the power adapter with the fast charging capability to charge this electronic device. Can this electronic device be fully charged within 10 minutes?”. Then, the fusion inference module generates, based on the processing of the text feature and the video content feature, an initial scene description text at the timestamp time_1. The content described in the initial scene description text is “A man uses the power adapter with the fast charging function to charge the electronic device with the 15% battery level and poses the question of whether it can be fully charged within 10 minutes”, resulting in effects that the “fast charging function” of the power adapter, which is not reflected in the video content feature of the material video, is supplemented by the text feature, while the “connection action of the electronic device to the power adapter and the charging state after connection”, which are not reflected in the text feature, are supplemented by the video content feature. That is, through multi-source multimodal information complementarity, the detailed and rich initial scene description text is generated, providing accurate and abundant intermediate process data (the initial scene description text).

Further, in a possible implementation, the video content feature includes a first video content feature and a second video content feature, wherein the first video content feature represents clip content of at least one video clip constituting the material video, and the second video content feature represents image content of at least one video frame in the material video. Correspondingly, in this case, a specific implementation for step S2022B includes:

Step S2022B-1: The material video is segmented based on preset storyboard information to obtain at least one video storyboard snippet, and feature extraction on the video storyboard snippet is performed through the image feature extraction module to obtain the first video content feature, wherein the storyboard information represents a time period corresponding to at least one video storyboard.

Exemplarily, for the first video content feature, since the material video includes at least one video storyboard snippet, the image feature extraction module respectively performs, according to the preset storyboard information, feature extraction on the video storyboard snippet segmented based on the material video, thereby obtaining the first video content feature corresponding to each video storyboard snippet, wherein the storyboard information corresponds to a time period of each video storyboard. Specifically, for example, the material video is composed of a video storyboard snippet clips_1, a video storyboard snippet clips_2, and a video storyboard snippet clips_3; a time period of the video storyboard snippet clips_1 is T_1, a time period of the video storyboard snippet clips_2 is T_2, a time period of the video storyboard snippet clips_3 is T_3, and the time periods T_1, T_2, and T_3 jointly constitute the storyboard information. Then, by segmenting the material video based on the storyboard information, the video storyboard snippet clips_1, the video storyboard snippet clips_2, and the video storyboard snippet clips_3 can be obtained, and then, the image feature extraction module respectively performs feature extraction on the video storyboard snippet clips_1, clips_2, and clips_3 to obtain the first video content feature corresponding to each video storyboard snippet. Further, by summarizing the first video content feature of each video storyboard snippet, the first video content feature of the material video can be obtained.

Step S2022B-2: Frames from the material video are sampled, based on a preset time interval, to obtain at least one material video frame, and feature extraction is perform on the material video frame through the image feature extraction module to obtain the second video content feature.

Exemplarily, for the second video content feature, according to a video duration of the material video, the material video may be divided into a plurality of equal parts to obtain a plurality of material video scenes. That is, sample frames from the material video according to the preset time interval to obtain the at least one material video frame, and then the image feature extraction module performs feature extraction on the material video frames to obtain the corresponding second video content feature. Specifically, for example, for a 20-second material video, frame sampling may be performed on the material video every second, then, 20 material video frames may be obtained, and then the image feature extraction module respectively performs feature extraction on the 20 material video frames, thereby obtaining the corresponding second video content feature. Further, the second video content features of the 20 material video frames are summarized to obtain the second video content feature of the 20-second material video. It should be understood that for the 20-second material video, frame sampling is performed on the material video based on 500 milliseconds, thereby obtaining 40 material video frames. A subsequent feature extraction process is similar to the above-mentioned process, and details are not repeated herein.

In the steps of this embodiment, based on a time interval corresponding to the preset storyboard information, a coarse-grained first video content feature is extracted from the material video. Based on the preset time interval, a fine-grained second video content feature is extracted from the material video. Then, the first video content feature and the second video content feature are fused to obtain the video content feature, thereby improving the accuracy of extracting the video content information from the material video. The preset time interval corresponding to the second video content feature is smaller than the time interval corresponding to the storyboard information corresponding to the first video content feature.

Further, in a possible implementation, a specific implementation of processing the text feature and the video content feature through the fusion inference module to obtain the initial scene description text for the material video in step S2021D includes:

Step S2021D-1: The text feature and the video content feature are processed through the fusion inference module to obtain at least one chapter identification and a chapter scene description text corresponding to each chapter identification, wherein the chapter scene description text includes at least one initial scene description text, and the chapter scene description text is used to describe an image content under at least one video storyboard in a video chapter indicated by the corresponding chapter identification.

Exemplarily, based on different objects described by the text feature and the video content feature, the fusion inference module performs coarse-grained division on the text feature and the video content feature, namely, division by chapters, to obtain the corresponding at least one chapter identification, and respectively obtain the chapter scene description text corresponding to each chapter identification. Further, the chapter scene description text includes at least one initial scene description text. Specifically, for example, the material video is a commercial promotional video for a power adapter, and the material video may be divided into an application scenario video clip and a product introduction video clip. The fusion inference module divides the text feature and the video content feature into two chapters according to content emphasized by the text feature and the video content feature, thereby obtaining two chapter identifications. The first chapter identification is an “application scenario”, and the corresponding chapter scene description text is “An electronic device charges from a low battery level to a full charge state by connecting to the power adapter”. The second chapter identification is a “product introduction”, and the corresponding chapter scene description text is “The design concept of the power adapter and the types of electronic devices it targets”. Further, for the text feature and the video content feature corresponding to the first chapter identification “application scenario”, the fusion inference module performs further processing, thereby obtaining at least one initial scene description text. For example, for the chapter “application scenario”, three initial scene description texts are obtained. The first initial scene description text mainly describes “A man needs to fully charge the electronic device with the low battery level in a short time”. The second initial scene description text mainly describes “A charging process of the electronic device connected to the power adapter”. The third initial scene description text mainly describes “The electronic device is fully charged within 10 minutes”. The process of generating the initial scene description texts by the fusion inference module is similar to the process of the above-mentioned embodiment, and details are not repeated herein.

In the steps of this embodiment, the fusion inference module first performs coarse-grained chapter division on the text feature and the video content feature according to the content emphasized by the text feature and the video content feature, and then further processes the text feature and the video content feature of the various chapters, to generate the corresponding initial scene description text, thereby achieving the hierarchy and structure of the initial scene description texts, facilitating the multimodal processing model to process the initial scene description texts, and accurately generating the second script data.

Further, in a possible implementation, this embodiment further includes:

Step S2020A: User requirement information is acquired, wherein the user requirement information is used to represent a content requirement for the generated second script data.

Step S2020B: A corresponding model prompt is generated according to the user requirement information, wherein the model prompt include chapter information representing a chapter division rule.

Exemplarily, the user requirement information reflects the requirement of the user for the video to be shot, namely, reflecting the content requirement of the user for the multimodal processing model to generate the second script data. Therefore, the server generates the corresponding model prompt by analyzing and processing the acquired user requirement information, thereby allowing the multimodal processing model to generate the corresponding second script data according to the model prompt. Specifically, for example, the model prompt includes the chapter information representing the chapter division rule, and therefore the multimodal processing model performs chapter division on the material video according to the model prompt, thereby generating the corresponding second script data. It should be understood that the same material video may be divided into different chapter structures based on the different chapter prompts, and therefore the finally generated second script data is different based on different chapter structures, with each second script data having different corresponding focuses.

Correspondingly, in a possible implementation, a specific implementation of step S2021D-1 includes:
processing the text feature, the video content feature, and the model prompt through the fusion inference module to obtain the at least one chapter identification and the chapter scene description text corresponding to each chapter identification.

Exemplarily, for example, the material video is a commercial promotional video for a power adapter. The material video may be divided into an application scenario video clip and a product introduction video clip. If the model prompt is “Describe a shooting shot for a use application of a charger in detail”, the fusion inference module processes the text feature, the video content feature, and the model prompt to obtain four chapter identifications and chapter scene description texts corresponding to the chapter identifications, wherein the three chapter identifications correspond to the application scenario video clip of the material video for the detailed description of an application scenario of the power adapter, and the remaining chapter identification corresponds to the product introduction video clip of the material video. If the model prompt is “Describe a shooting shot for a product introduction about a charger in detail”, the fusion inference module also generates four chapter identifications, wherein the three chapter identifications correspond to the product introduction video clip of the material video, and the remaining chapter identification corresponds to the application scenario video clip of the material video.

In the steps of this embodiment, based on actual shooting requirements of the user, targeted processing is correspondingly performed on the material video. For example, chapter division is performed on the material video according to the user requirement information, thereby generating the personalized second script data satisfying user requirements, and then enhancing user experience of the user.

Step S203: User input data is acquired, wherein the user input data includes a video requirement parameter, and the video requirement parameter at least represents a video content feature of a video to be generated.

Step S204: The user input data and the second script data are processed through a pre-trained large language model to generate first script data of the video to be generated.

Exemplarily, the pre-trained large language model matches, based on the user input data, the corresponding second script data from a database and performs adaptive processing, thereby generating the first script data. Specifically, for example, the user input data data_0 is “Generate a video script of introducing a power adapter with a fast charging function”, the second script data data_1 is script data of shooting the user using the electronic device, the second script data data_2 is script data of shooting a power adapter production process, the second script data data_3 is script data of shooting phone charging, and accordingly, the pre-trained large language model determines the second script data data_3 as matching script data according to the user input data data_0, thereby adaptively processing the second script data data_3, to generate the first script data. The material video corresponding to the above-mentioned second script data data_1, data_2, and data_3 may be video data automatically retrieved by the server from the database, or video data determined based on usage habits of the user (likes, favorites, views, and shares, the usage habits including at least one of the above-mentioned usage behaviors), or reference video data uploaded by the user synchronously when the user inputs the user input data data_0.

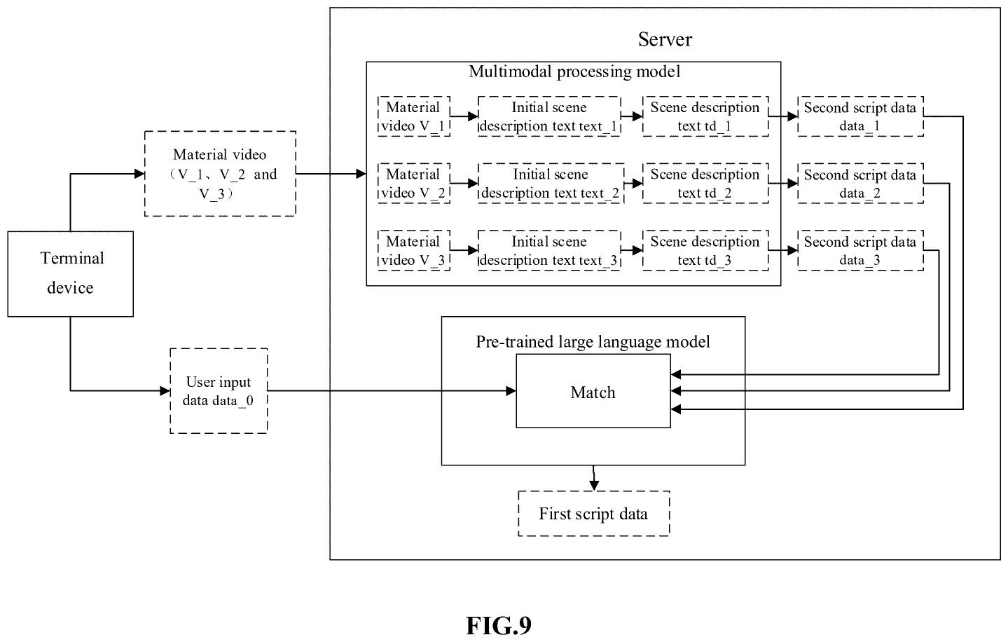

FIG. 9 is a schematic diagram of a process of generating first script data of a video to be generated according to an embodiment of the present disclosure. The following is a more detailed introduction of the above-mentioned process in conjunction with FIG. 9. As shown in FIG. 9, taking the case that “a user synchronously uploads reference video data when inputting user input data data_0” as an example, firstly, the user inputs the user input data data_0 and a material video (i.e., the reference video data) through a terminal device, then, the terminal device sends the inputted user input data data_0 and the material video to a server, the server processes the material video by invoking a multimodal processing model to obtain second script data data_1, data_2, and data_3, and then the server invokes a pre-trained large language model to match the user input data data_0 and the second script data data_1, data_2, and data_3, thereby determining matching script data. The matching script data is the second script data data_3, and then the pre-trained large language model generates the first script data based on the user input data data_0 and the second script data data_3 matching data_0. The process that the server processes the material video by invoking the multimodal processing model to obtain the second script data data_1, data_2, and data_3 includes: for example, the user uploading three material videos (V_1, V_2, and V_3), the multimodal processing model processing the three material videos to obtain corresponding initial scene description texts text_1, text_2, and text_3, then personalized description information from the initial scene description texts being respectively separated to obtain a scene description text td_1 for the material video V_1, a scene description text td_2 for the material video V_2, and a scene description text td_3 for the material video V_3, and then the multimodal processing model generating, based on the scene description texts, the corresponding second script data data_1, data_2, and data_3.

In this embodiment, an implementation of step S203 is the same as that of step S101 in the embodiment shown in FIG. 2 of the present disclosure, which will not be elaborated herein.

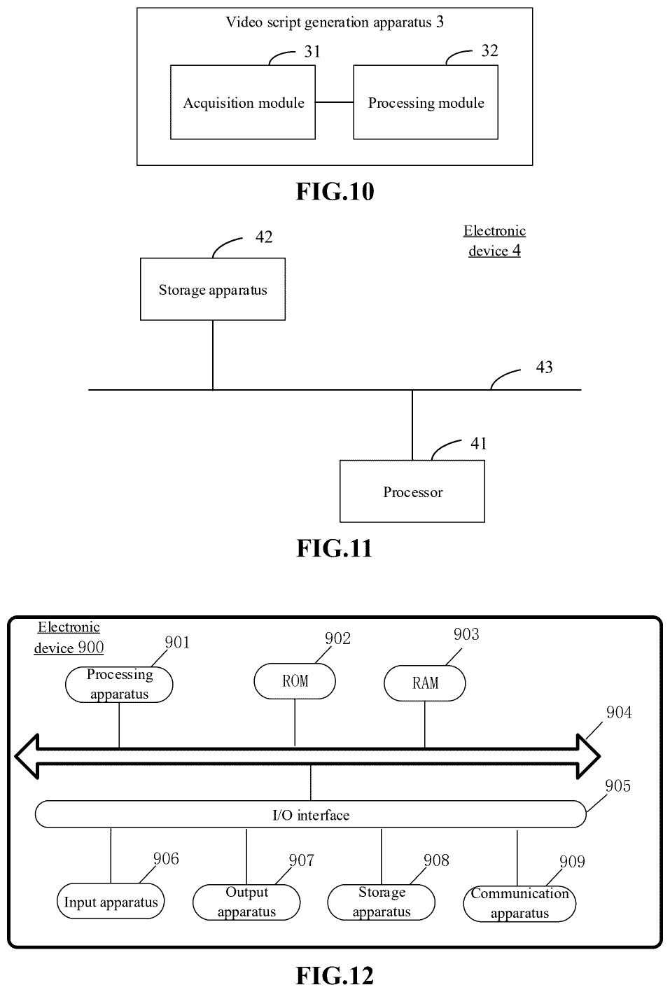

Corresponding to the video script generation method in the above-mentioned embodiments, FIG. 10 is a structural block diagram of a video script generation apparatus according to an embodiment of the present disclosure. The method introduced in the above-mentioned embodiments may be performed by the video script generation apparatus. The apparatus may be implemented by software and/or hardware. The apparatus may be integrated into an electronic device with a certain data processing function. The electronic device may include, but is not limited to, a mobile terminal with a big data processing capability, as well as a fixed terminal with the big data processing capability such as a desktop computer and a supercomputer.

To facilitate the description, only the parts related to this embodiment of the present disclosure are shown. Referring to FIG. 10, the video script generation apparatus 3 includes:
an acquisition unit 31, configured to acquire user input data, wherein the user input data includes a video requirement parameter, and the video requirement parameter at least represents a video content feature of a video to be generated; and
a processing unit 32, configured to process the user input data through a pre-trained large language model to generate first script data, wherein the first script data includes at least two scene description texts for the video to be generated, and the scene description texts are used to describe image content under a video storyboard in the video.

According to one or more embodiments of the present disclosure, the user input data further includes a video copy. The first script data includes at least two copy clauses constituting the video copy, the copy clauses correspond one-to-one with the scene description texts, and the scene description texts are generated based on corresponding copy clauses.

According to one or more embodiments of the present disclosure, the video script generation apparatus 3 is further configured to: acquire a material video; and process the material video through a multimodal processing model to obtain second script data, wherein the second script data includes at least two scene description texts for the material video. The processing unit 32, when processing the user input data through the pre-trained large language model to generate the first script data of the video to be generated, is specifically configured to: process the user input data and the second script data through the pre-trained large language model to generate the first script data of the video to be generated.

According to one or more embodiments of the present disclosure, the video script generation apparatus 3, when processes the material video through the multimodal processing model to obtain the second script data, is specifically configured to: process the material video through the multimodal processing model to obtain an initial scene description text for the material video; separate personalized description information from the initial scene description text to obtain a scene description text for the material video; and generate the second script data according to the scene description text for the material video.

According to one or more embodiments of the present disclosure, the multimodal processing model includes an image feature extraction module, a text feature extraction module, and a fusion inference module. The video script generation apparatus 3, when processes the material video through the multimodal processing model to obtain the initial scene description text for the material video, is specifically configured to: extract a copy text in the material video through the text feature extraction module, wherein the copy text is used to represent text content and/or dialogue content appearing in the material video; extract a video content feature of the material video through the image feature extraction module, wherein the video content feature is used to represent video content information of the material video; convert the video content information into a corresponding content description text; and fuse the copy text and the content description text into a text feature, and process the text feature and the video content feature through the fusion inference module to obtain the initial scene description text for the material video.

According to one or more embodiments of the present disclosure, the video content feature includes a first video content feature and a second video content feature, wherein the first video content feature represents a clip content of at least one video clip constituting the material video, and the second video content feature represents image content of at least one video frame in the material video. The video script generation apparatus 3, when extracts the video content feature of the material video through the image feature extraction module, is specifically configured to: segment the material video based on preset storyboard information to obtain at least one video storyboard snippet, and perform feature extraction on the video storyboard snippet through the image feature extraction module to obtain the first video content feature, wherein the storyboard information represents a time period corresponding to at least one video storyboard; and sample, based on a preset time interval, frames from the material video to obtain at least one material video frame, and perform feature extraction on the material video frame through the image feature extraction module to obtain the second video content feature.

According to one or more embodiments of the present disclosure, the video script generation apparatus 3, when processes the text feature and the video content feature through the fusion inference module to obtain the initial scene description text for the material video, is specifically configured to: process the text feature and the video content feature through the fusion inference module to obtain at least one chapter identification and a chapter scene description text corresponding to each chapter identification, wherein the chapter scene description text includes at least one initial scene description text, and the chapter scene description text is used to describe image content under at least one video storyboard in a video chapter indicated by a corresponding chapter identification.

According to one or more embodiments of the present disclosure, the video script generation apparatus 3 is further configured to: acquire user requirement information, wherein the user requirement information is used to represent a content requirement for the generated second script data; and generate a corresponding model prompt according to the user requirement information, wherein the model prompt include chapter information representing a chapter division rule. The video script generation apparatus 3, when processes the text feature and the video content feature through the fusion inference module to obtain the at least one chapter identification and the chapter scene description text corresponding to each chapter identification, is specifically configured to: process the text feature, the video content feature, and the model prompt through the fusion inference module to obtain the at least one chapter identification and the chapter scene description text corresponding to each chapter identification.

According to one or more embodiments of the present disclosure, the video script generation apparatus 3 is further configured to: generate a shooting guidance video of the video to be generated according to the first script data, wherein the shooting guidance video includes at least two shooting guidance video frames corresponding one-to-one with the scene description texts for the video to be generated, and a corresponding scene description text is displayed within each shooting guidance video frame.

The acquisition unit 31 is connected with the processing unit 32. The video script generation apparatus 3 provided in this embodiment may perform the technical solutions in the above-mentioned method embodiments, and the implementation principle and technical effects are similar to those as above, which are not further described in this embodiment.

FIG. 11 is a schematic structural diagram of an electronic device according to an embodiment of the present disclosure. As shown in FIG. 11, the electronic device 4 includes:
a processor 41, and a storage apparatus 42 which is in communication connection with the processor 41.

The storage apparatus 42 stores computer-executable instructions.

The processor 41 executes the computer-executable instructions stored in the storage apparatus 42 to implement the video script generation method in the embodiments shown in FIG. 2 to FIG. 9.

Optionally, the processor 41 and the storage apparatus 42 are connected through a bus 43.

The relevant explanations may be understood by referring to the relevant descriptions and effects corresponding to the steps in the embodiments corresponding to FIG. 2 to FIG. 9, which are not further described herein.

An embodiment of the present disclosure provides a computer-readable storage medium, and the computer-readable storage medium stores computer-executable instructions therein. The computer-executable instructions, when executed by a processor, are used to implement the video script generation method provided in any of the embodiments of the present disclosure corresponding to FIG. 2 to FIG. 9.

An embodiment of the present disclosure provides a computer program product, and the computer program product includes a computer program. The computer program, when executed by a processor, implements the video script generation method provided in any of the embodiments of the present disclosure corresponding to FIG. 2 to FIG. 9.

To implement the above-mentioned embodiments, an embodiment of the present disclosure further provides an electronic device.

Referring to FIG. 12, FIG. 12 is a schematic diagram of a hardware structure of an electronic device according to an embodiment of the present disclosure, illustrating a schematic structural diagram of an electronic device 900 applicable to implementing embodiments of the present disclosure. The electronic device 900 may be a terminal device or a server. The terminal device may include, but is not limited to, a mobile terminal such as a mobile phone, a notebook computer, a digital broadcast receiver, a personal digital assistant (PDA), a tablet computer, a portable media player (PMP), and a vehicle-mounted terminal (e.g., a vehicle navigation terminal), and a fixed terminal such as a digital TV and a desktop computer. The electronic device shown in FIG. 12 is merely an example, which should not impose any limitations on functions and application ranges of this embodiment of the present disclosure.

As shown in FIG. 12, the electronic device 900 may include a processing apparatus (e.g., a central processing unit and a graphics processing unit) 901, which may perform various appropriate actions and processing according to programs stored in a read only memory (ROM) 902 or loaded from a storage apparatus 908 into a random access memory (RAM) 903. The RAM 903 further stores various programs and data required for the operation of the electronic device 900. The processing apparatus 901, the ROM 902, and the RAM 903 are connected to one another through a bus 904. An input/output (I/O) interface 905 is also connected to the bus 904.

Typically, the following apparatuses may be connected to the I/O interface 905: an input apparatus 906, including, for example, a touchscreen, a touchpad, a keyboard, a mouse, a camera, a microphone, an accelerometer, and a gyroscope; an output apparatus 907, including, for example, a liquid crystal display (LCD), a speaker, and a vibrator; the storage apparatus 908, including, for example, a magnetic tape and a hard drive; and a communication apparatus 909. The communication apparatus 909 may allow the electronic device 900 to be in wireless or wired communication with other devices for data exchange. Although FIG. 12 shows the electronic device 900 having various apparatuses, it should be understood that it is not required to implement or have all of the shown apparatuses. It may be an alternative to implement or have more or fewer apparatuses.

In particular, according to the embodiments of the present disclosure, the process described above with reference to the flowchart may be implemented as a computer software program. For example, an embodiment of the present disclosure includes a computer program product including a computer program carried on a computer-readable medium. The computer program includes program code for performing the method shown in the flowchart. In this embodiment, the computer program may be downloaded and installed from the network through the communication apparatus 909, installed from the storage apparatus 908, or installed from the ROM 902. The computer program, when executed by the processing apparatus 901, performs the above-mentioned functions limited in the method in this embodiment of the present disclosure.

It should be noted that the above-mentioned computer-readable medium in the present disclosure may be either a computer-readable signal medium or a computer-readable storage medium, or any combination of the two. The computer-readable storage medium may be, for example but is not limited to, electric, magnetic, optical, electromagnetic, infrared, or semiconductor systems, apparatuses, or devices, or any combination thereof. More specific examples of the computer-readable storage medium may include, but are not limited to: an electrical connection with one or more wires, a portable computer disk, a hard drive, a random access memory (RAM), a read only memory (ROM), an erasable programmable read only memory (EPROM or a flash memory), an optical fiber, a portable compact disk read only memory (CD-ROM), an optical storage device, a magnetic storage device, or any suitable combination of the above. In the present disclosure, the computer-readable storage medium may be any tangible medium including or storing a program, and the program may be for use by or for use in combination with an instruction execution system, apparatus, or device. However, in the present disclosure, the computer-readable signal medium may include a data signal propagated in a baseband or as a part of a carrier, wherein the data signal carries computer-readable program code. The propagated data signal may take various forms, including but not limited to, an electromagnetic signal, an optical signal, or any suitable combination of the above. The computer-readable signal medium may further be any computer-readable medium other than the computer-readable storage medium. The computer-readable signal medium may send, propagate, or transmit a program used by or in conjunction with the instruction execution system, apparatus, or device. The program code included in the computer-readable medium may be transmitted by any suitable medium, including but not limited to a wire, an optical cable, radio frequency (RF), etc., or any suitable combination of the above.

The above-mentioned computer-readable medium may be included in the above-mentioned electronic device; or may also separately exist without being assembled in the electronic device.

The above-mentioned computer-readable medium carries one or more programs. The above-mentioned one or more programs, when executed by the electronic device, cause the electronic device to perform the method shown in the above-mentioned embodiments.

Computer program code for performing the operations in the present disclosure may be written in one or more programming languages or a combination thereof, and the above-mentioned programming languages include an object-oriented programming language, such as Java, Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or the server. In the case of involving the remote computer, the remote computer may be connected to the user computer via any type of network, including a local area network (LAN) or wide area network (WAN), or may be connected to an external computer (e.g., utilizing an Internet service provider for Internet connectivity).

The flowcharts and the block diagrams in the accompanying drawings illustrate the possibly implemented system architecture, functions, and operations of the system, the method, and the computer program product according to various embodiments of the present disclosure. In this regard, each block in the flowcharts or the block diagrams may represent a module, a program segment, or a part of code, and the module, the program segment, or the part of code contains one or more executable instructions for implementing specified logical functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagrams and/or the flowcharts, and a combination of the blocks in the block diagrams and/or the flowcharts may be implemented using a dedicated hardware-based system that performs specified functions or operations, or may be implemented using a combination of dedicated hardware and computer instructions.

The units or modules described in the embodiments of the present disclosure may be implemented through software or hardware. The name of the unit or the module does not constitute a limitation on the unit itself under certain circumstances.

Herein, the functions described above may be performed at least partially by one or more hardware logic components. For example, without limitation, exemplary hardware logic components that can be used include: a field-programmable gate array (FPGA), an application specific integrated circuit (ASIC), an application specific standard product (ASSP), a system on chip (SOC), a complex programmable logic device (CPLD), etc.

In the context of the present disclosure, a machine-readable medium may be a tangible medium that may include or store a program for use by or for use in conjunction with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above-mentioned content. More specific examples of the machine-readable storage medium may include an electrical connection based on one or more wires, a portable computer disk, a hard drive, a random access memory (RAM), a read only memory (ROM), an erasable programmable read only memory (EPROM or a flash memory), an optical fiber, a portable compact disk read only memory (CD-ROM), an optical storage device, a magnetic storage device, or any suitable combination of the above-mentioned content.

In a first aspect, according to one or more embodiments of the present disclosure, a video script generation method is provided, and includes:
acquiring user input data, wherein the user input data includes a video requirement parameter, and the video requirement parameter at least represents a video content feature of a video to be generated; and processing the user input data through a pre-trained large language model to generate first script data, wherein the first script data includes at least two scene description texts for the video to be generated, and the scene description texts are used to describe image content under a video storyboard in a target video.

According to one or more embodiments of the present disclosure, the user input data further includes a video copy; and the first script data includes at least two copy clauses constituting the video copy, the copy clauses correspond one-to-one with the scene description texts, and the scene description texts are generated based on corresponding copy clauses.

According to one or more embodiments of the present disclosure, the method further includes: acquiring a material video; and processing the material video through a multimodal processing model to obtain second script data, wherein the second script data includes at least two scene description texts for the material video. Processing the user input data through the pre-trained large language model to generate the first script data includes: processing the user input data and the second script data through the pre-trained large language model to generate first script data of the video to be generated.

According to one or more embodiments of the present disclosure, processing the material video through the multimodal processing model to obtain the second script data includes: processing the material video through the multimodal processing model to obtain an initial scene description text for the material video; separating personalized description information from the initial scene description text to obtain a scene description text for the material video; and generating the second script data according to the scene description text for the material video.

According to one or more embodiments of the present disclosure, the multimodal processing model includes an image feature extraction module, a text feature extraction module, and a fusion inference module. Processing the material video through the multimodal processing model to obtain the initial scene description text for the material video includes: extracting a copy text in the material video through the text feature extraction module, wherein the copy text is used to represent text content and/or dialogue content appearing in the material video; extracting a video content feature of the material video through the image feature extraction module, wherein the video content feature is used to represent video content information of the material video; converting the video content information into a corresponding content description text; and fusing the copy text and the content description text into a text feature, and processing the text feature and the video content feature through the fusion inference module to obtain the initial scene description text for the material video.

According to one or more embodiments of the present disclosure, the video content feature includes a first video content feature and a second video content feature, wherein the first video content feature represents clip content of at least one video clip constituting the material video, the second video content feature represents image content of at least one video frame in the material video. Extracting the video content feature of the material video through the image feature extraction module includes: segmenting the material video based on preset storyboard information to obtain at least one video storyboard snippet, and performing feature extraction on the video storyboard snippet through the image feature extraction module to obtain the first video content feature, wherein the storyboard information represents a time period corresponding to at least one video storyboard; and sampling, based on a preset time interval, frames from the material video to obtain at least one material video frame, and performing feature extraction on the material video frame through the image feature extraction module to obtain the second video content feature.

According to one or more embodiments of the present disclosure, the processing the text feature and the video content feature through the fusion inference module to obtain the initial scene description text for the material video includes: processing the text feature and the video content feature through the fusion inference module to obtain at least one chapter identification and a chapter scene description text corresponding to each chapter identification, wherein the chapter scene description text includes at least one initial scene description text, and the chapter scene description text is used to describe image content under at least one video storyboard in a video chapter indicated by a corresponding chapter identification.

According to one or more embodiments of the present disclosure, the method further includes: acquiring user requirement information, wherein the user requirement information is used to represent a content requirement for the generated second script data; and generating a corresponding model prompt according to the user requirement information, wherein the model prompt include chapter information representing a chapter division rule. Processing the text features and the video content features through the fusion inference module to obtain the at least one chapter identification and the chapter scene description text corresponding to each chapter identification includes: processing the text feature, the video content feature, and the model prompt through the fusion inference module to obtain the at least one chapter identification and the chapter scene description text corresponding to each chapter identification.

According to one or more embodiments of the present disclosure, the method further includes: generating a shooting guidance video of the video to be generated according to the first script data, wherein the shooting guidance video includes at least two shooting guidance video frames corresponding one-to-one with the scene description texts for the video to be generated, and a corresponding scene description text is displayed within each shooting guidance video frame.

In a second aspect, according to one or more embodiments of the present disclosure, a video script generation apparatus is provided, and includes:
an acquisition unit, configured to acquire user input data, wherein the user input data includes a video requirement parameter, and the video requirement parameter at least represents a video content feature of a video to be generated; and
a processing unit, configured to process the user input data through a pre-trained large language model to generate first script data, wherein the first script data includes at least two scene description texts for the video to be generated, and the scene description texts are used to describe image content under a video storyboard in a target video.

According to one or more embodiments of the present disclosure, the user input data further includes a video copy; and the first script data includes at least two copy clauses constituting the video copy, the copy clauses correspond one-to-one with the scene description texts, and the scene description texts are generated based on corresponding copy clauses.

According to one or more embodiments of the present disclosure, the video script generation apparatus is further configured to: acquire a material video; and process the material video through a multimodal processing model to obtain second script data, wherein the second script data includes at least two scene description texts for the material video. The processing unit, when processes the user input data through the pre-trained large language model to generate the first script data, is specifically configured to: process the user input data and the second script data through the pre-trained large language model to generate the first script data of the video to be generated.

According to one or more embodiments of the present disclosure, the video script generation apparatus, when processes the material video through a multimodal processing model to obtain the second script data, is specifically configured to: process the material video through the multimodal processing model to obtain an initial scene description text for the material video; separate personalized description information from the initial scene description text to obtain a scene description text for the material video; and generate the second script data according to the scene description text for the material video.

According to one or more embodiments of the present disclosure, the multimodal processing model includes an image feature extraction module, a text feature extraction module, and a fusion inference module. The video script generation apparatus, when processes the material video through the multimodal processing model to obtain the initial scene description text for the material video, is specifically configured to: extract a copy text in the material video through the text feature extraction module, wherein the copy text is used to represent text content and/or dialogue content appearing in the material video; extract a video content feature of the material video through the image feature extraction module, wherein the video content feature is used to represent video content information of the material video; convert the video content information into a corresponding content description text; and fuse the copy text and the content description text into a text feature, and process the text feature and the video content feature through the fusion inference module to obtain an initial scene description text for the material video.

According to one or more embodiments of the present disclosure, the video content feature includes a first video content feature and a second video content feature, wherein the first video content feature represents clip content of at least one video clip constituting the material video, the second video content feature represents image content of at least one video frame in the material video. The video script generation apparatus, when extracts the video content feature of the material video through the image feature extraction module, is specifically configured to: segment the material video based on preset storyboard information to obtain at least one video storyboard snippet, and perform feature extraction on the video storyboard snippet through the image feature extraction module to obtain the first video content feature, wherein the storyboard information represents a time period corresponding to at least one video storyboard; and sample, based on a preset time interval, frames from the material video to obtain at least one material video frame, and perform feature extraction on the material video frame through the image feature extraction module to obtain the second video content feature.

According to one or more embodiments of the present disclosure, the video script generation apparatus, when processes the text feature and the video content feature through the fusion inference module to obtain the initial scene description text for the material video, is specifically configured to: process the text feature and the video content feature through the fusion inference module to obtain at least one chapter identification and a chapter scene description text corresponding to each chapter identification, wherein the chapter scene description text includes at least one initial scene description text, and the chapter scene description text is used to describe image content under at least one video storyboard in a video chapter indicated by a corresponding chapter identification.

According to one or more embodiments of the present disclosure, the video script generation apparatus is further configured to: acquire user requirement information, wherein the user requirement information is used to represent a content requirement for the generated second script data; and generate a corresponding model prompt according to the user requirement information, wherein the model prompt includes chapter information representing a chapter division rule. The video script generation apparatus, when processes the text feature and the video content feature through the fusion inference module to obtain at least one chapter identification and the chapter scene description text corresponding to each chapter identification, is specifically configured to: process the text feature, the video content feature, and the model prompt through the fusion inference module, to obtain the at least one chapter identification and the chapter scene description text corresponding to each chapter identification.

According to one or more embodiments of the present disclosure, the video script generation apparatus is further configured to: generate a shooting guidance video of the video to be generated according to the first script data, wherein the shooting guidance video includes at least two shooting guidance video frames corresponding one-to-one with the scene description texts for the video to be generated, and a corresponding scene description text is displayed within each shooting guidance video frame.

In a third aspect, according to one or more embodiments of the present disclosure, an electronic device is provided, and the electronic device includes at least one processor and a storage apparatus;
the storage apparatus stores computer-executable instructions; and
the at least one processor executes the computer-executable instructions stored in the storage apparatus, to cause the at least one processor to perform the video script generation method according to the first aspect and various possible designs in the first aspect described above.

In a fourth aspect, according to one or more embodiments of the present disclosure, a computer-readable storage medium is provided and the computer-readable storage medium stores computer-executable instructions therein. A processor, when executes the computer-executable instructions, implements the video script generation method according to the first aspect and various possible designs in the first aspect described above.

In a fifth aspect, according to one or more embodiments of the present disclosure, a computer program product is provided, and the computer program product includes a computer program. The computer program, when executed by a processor, implements the video script generation method according to the first aspect and various possible designs in the first aspect described above.

The above-mentioned descriptions are merely preferred embodiments of the present disclosure and explanations of the applied technical principles. Those skilled in the art should understand that the scope of disclosure involved in the present disclosure is not limited to the technical solutions formed by specific combinations of the above-mentioned technical features, and shall also cover other technical solutions formed by any combination of the above-mentioned technical features or equivalent features thereof without departing from the above-mentioned concept of disclosure. For example, a technical solution formed by a replacement of the above-mentioned features with technical features with similar functions disclosed in the present disclosure (but not limited thereto) also falls within the scope of the present disclosure.

Further, although the operations are described in a particular order, it should not be understood as requiring these operations to be performed in the shown particular order or in a sequential order. In certain environments, multitasking and parallel processing may be advantageous. Similarly, although several specific implementation details are included in the above discussion, these specific implementation details should not be interpreted as limitations on the scope of the present disclosure. Some features that are described in the context of separate embodiments may also be implemented in combination in a single embodiment. In contrast, various features described in the context of a single embodiment may also be implemented in a plurality of embodiments individually or in any suitable sub combination.

Although the subject matter has been described in a language specific to structural features and/or logic actions of the method, it should be understood that the subject matter defined in the appended claims is not necessarily limited to the specific features or actions described above. On the contrary, the specific features and the actions described above are merely example forms for implementing the claims.

I/We claim:

1. A video script generation method, comprising:
acquiring user input data, the user input data comprising a video requirement parameter, and the video requirement parameter at least representing a video content feature of a video to be generated; and
processing the user input data through a pre-trained large language model to generate first script data, the first script data comprising at least two scene description texts for the video to be generated, and the scene description texts being used to describe image content under a video storyboard in a target video.

2. The method according to claim 1, wherein the user input data further comprises a video copy; and
the first script data comprises at least two copy clauses constituting the video copy, the copy clauses correspond one-to-one with the scene description texts, and the scene description texts are generated based on corresponding copy clauses.

3. The method according to claim 1, further comprising:
acquiring a material video;
processing the material video through a multimodal processing model to obtain second script data, the second script data comprising at least two scene description texts for the material video; and
processing the user input data through the pre-trained large language model to generate the first script data, comprising:
processing the user input data and the second script data through the pre-trained large language model to generate the first script data of the video to be generated.

4. The method according to claim 3, wherein processing the material video through the multimodal processing model to obtain the second script data comprises:
processing the material video through the multimodal processing model to obtain an initial scene description text for the material video;
separating personalized description information from the initial scene description text to obtain a scene description text for the material video; and
generating the second script data according to the scene description text for the material video.

5. The method according to claim 4, wherein the multimodal processing model comprises an image feature extraction module, a text feature extraction module, and a fusion inference module, and processing the material video through the multimodal processing model to obtain the initial scene description text for the material video comprises:
extracting a copy text in the material video through the text feature extraction module, the copy text being used to represent text content and/or dialogue content appearing in the material video;
extracting a video content feature of the material video through the image feature extraction module, the video content feature being used to represent video content information of the material video;
converting the video content information into a corresponding content description text; and
fusing the copy text and the content description text into a text feature, and processing the text feature and the video content feature through the fusion inference module to obtain an initial scene description text for the material video.

6. The method according to claim 5, wherein the video content feature comprises a first video content feature and a second video content feature, the first video content feature represents clip content of at least one video clip constituting the material video, the second video content feature represents image content of at least one video frame in the material video;
extracting the video content feature of the material video through the image feature extraction module comprises:
segmenting the material video based on preset storyboard information to obtain at least one video storyboard snippet, and performing feature extraction on the video storyboard snippet through the image feature extraction module to obtain the first video content feature, the storyboard information representing a time period corresponding to at least one video storyboard; and
sampling, based on a preset time interval, frames from the material video to obtain at least one material video frame, and performing feature extraction on the material video frame through the image feature extraction module to obtain the second video content feature.

7. The method according to claim 5, wherein processing the text feature and the video content feature through the fusion inference module to obtain the initial scene description text for the material video comprises:
processing the text feature and the video content feature through the fusion inference module to obtain at least one chapter identification and a chapter scene description text corresponding to each chapter identification,
wherein the chapter scene description text comprises at least one initial scene description text, and the chapter scene description text is used to describe image content under at least one video storyboard in a video chapter indicated by a corresponding chapter identification.

8. The method according to claim 7, further comprising:
acquiring user requirement information, the user requirement information being used to represent a content requirement for the generated second script data; and
generating a corresponding model prompt according to the user requirement information, the model prompt comprising chapter information representing a chapter division rule;
wherein processing the text feature and the video content feature through the fusion inference module to obtain the at least one chapter identification and the chapter scene description text corresponding to each chapter identification comprises:
processing the text feature, the video content feature, and the model prompt through the fusion inference module to obtain the at least one chapter identification and the chapter scene description text corresponding to each chapter identification.

9. The method according to claim 1, further comprising:
generating a shooting guidance video of the video to be generated according to the first script data, wherein the shooting guidance video comprises at least two shooting guidance video frames corresponding one-to-one with the scene description texts for the video to be generated, and a corresponding scene description text is displayed within each shooting guidance video frame.

10. An electronic device, comprising a processor and a storage apparatus,
wherein the storage apparatus stores computer-executable instructions; and
the processor, when executes the computer-executable instructions stored in the storage apparatus, causes the processor to:
acquire user input data, the user input data comprising a video requirement parameter, and the video requirement parameter at least representing a video content feature of a video to be generated; and
process the user input data through a pre-trained large language model to generate first script data, the first script data comprising at least two scene description texts for the video to be generated, and the scene description texts being used to describe image content under a video storyboard in a target video.

11. The electronic device according to claim 10, wherein the user input data further comprises a video copy; and
the first script data comprises at least two copy clauses constituting the video copy, the copy clauses correspond one-to-one with the scene description texts, and the scene description texts are generated based on corresponding copy clauses.

12. The electronic device according to claim 10, wherein the computer-executable instructions further cause the processor to:
acquire a material video;
process the material video through a multimodal processing model to obtain second script data, the second script data comprising at least two scene description texts for the material video; and
the computer-executable instructions causing the processor to process the user input data through the pre-trained large language model to generate the first script data further cause the processor to:
process the user input data and the second script data through the pre-trained large language model to generate the first script data of the video to be generated.

13. The electronic device according to claim 12, wherein the computer-executable instructions causing the processor to process the material video through the multimodal processing model to obtain the second script data further cause the processor to:
process the material video through the multimodal processing model to obtain an initial scene description text for the material video;
separate personalized description information from the initial scene description text to obtain a scene description text for the material video; and
generate the second script data according to the scene description text for the material video.

14. The electronic device according to claim 13, wherein the multimodal processing model comprises an image feature extraction module, a text feature extraction module, and a fusion inference module, and the computer-executable instructions causing the processor to process the material video through the multimodal processing model to obtain the initial scene description text for the material video further cause the processor to:
extract a copy text in the material video through the text feature extraction module, the copy text being used to represent text content and/or dialogue content appearing in the material video;
extract a video content feature of the material video through the image feature extraction module, the video content feature being used to represent video content information of the material video;
convert the video content information into a corresponding content description text; and
fuse the copy text and the content description text into a text feature, and process the text feature and the video content feature through the fusion inference module to obtain an initial scene description text for the material video.

15. The electronic device according to claim 14, wherein the video content feature comprises a first video content feature and a second video content feature, the first video content feature represents clip content of at least one video clip constituting the material video, the second video content feature represents image content of at least one video frame in the material video;
the computer-executable instructions causing the processor to extract the video content feature of the material video through the image feature extraction module further cause the processor to:
segment the material video based on preset storyboard information to obtain at least one video storyboard snippet, and perform feature extraction on the video storyboard snippet through the image feature extraction module to obtain the first video content feature, the storyboard information representing a time period corresponding to at least one video storyboard; and
sample, based on a preset time interval, frames from the material video to obtain at least one material video frame, and performing feature extraction on the material video frame through the image feature extraction module to obtain the second video content feature.

16. The electronic device according to claim 14, wherein the computer-executable instructions causing the processor to process the text feature and the video content feature through the fusion inference module to obtain the initial scene description text for the material video further cause the processor to:
process the text feature and the video content feature through the fusion inference module to obtain at least one chapter identification and a chapter scene description text corresponding to each chapter identification,
wherein the chapter scene description text comprises at least one initial scene description text, and the chapter scene description text is used to describe image content under at least one video storyboard in a video chapter indicated by a corresponding chapter identification.

17. The electronic device according to claim 16, wherein the computer-executable instructions further cause the processor to:
acquire user requirement information, the user requirement information being used to represent a content requirement for the generated second script data; and
generate a corresponding model prompt according to the user requirement information, the model prompt comprising chapter information representing a chapter division rule;
and the computer-executable instructions causing the processor to process the text feature and the video content feature through the fusion inference module to obtain the at least one chapter identification and the chapter scene description text corresponding to each chapter identification further cause the processor to:
process the text feature, the video content feature, and the model prompt through the fusion inference module to obtain the at least one chapter identification and the chapter scene description text corresponding to each chapter identification.

18. The electronic device according to claim 10, wherein the computer-executable instructions further cause the processor to:
generate a shooting guidance video of the video to be generated according to the first script data, wherein the shooting guidance video comprises at least two shooting guidance video frames corresponding one-to-one with the scene description texts for the video to be generated, and a corresponding scene description text is displayed within each shooting guidance video frame.

19. A non-transitory computer-readable storage medium storing computer-executable instructions therein, wherein when the computer-executable instructions are executed by a processor, the computer-executable instructions cause the processor to:
acquire user input data, the user input data comprising a video requirement parameter, and the video requirement parameter at least representing a video content feature of a video to be generated; and
process the user input data through a pre-trained large language model to generate first script data, the first script data comprising at least two scene description texts for the video to be generated, and the scene description texts being used to describe image content under a video storyboard in a target video.

20. The non-transitory computer-readable storage medium according to claim 19, wherein the user input data further comprises a video copy; and
the first script data comprises at least two copy clauses constituting the video copy, the copy clauses correspond one-to-one with the scene description texts, and the scene description texts are generated based on corresponding copy clauses.
